(19) United States
(12) Patent Application Publication
(10) Pub. No.: US 2002/0150738 A1
(43) Pub. Date: Oct. 17, 2002

(54) Masking material and a method of masking using same

(76) Inventor: Phillip J. Bouic, Warwicks (GB)

Correspondence Address: Office of Intellectual Property Counsel, 3M Innovative Properties Company, PO Box 33427, St. Paul, MN, 55133-3427, US

(21) Appl. No.: 10/121,491

(22) Filed: Apr. 12, 2002

(30) Foreign Application Priority Data
Apr. 12, 2001 (GB) 0109176.8

(51) Int. Cl. B32B 27/14; B32B 9/00

(52) U.S. Cl. 428/195; 428/40.1; 428/43

(57) ABSTRACT

A masking material 1 has differently colored portions 2, 3 producing a sight line 22 to assist locating the material 1 along a swage line 20 of a vehicle body part 21. The material 1 can be secured in either one of two orientations to arrange the portions 2, 3 to produce a sight line 22 for use with light and dark colored vehicles. Adhesive stripes 2a, 3a are provided on each side of the material 1 for sticking the material to the body part 21 in each orientation and the exposed strip may be used to attach masking paper if required.

This application claims priority to United Kingdom Patent Application Number 0109176.8, filed Apr. 12, 2001.

### FIELD

This invention relates to masking material particularly, but not exclusively, for masking a swage line of motor vehicle bodywork prior to spray painting the bodywork. A swage line is where there is a change in contour of the bodywork. The invention also relates to methods of making and using the masking material.

### BACKGROUND

Masking materials are used to mask off an area to be painted. Generally, masking materials have different characteristics depending on the purpose for which the materials are intended to be used.

In EP-A-0 384 626, for example, there is disclosed a foam material which is particularly suited for use as a masking material for filling gaps between a door and frame, bonnet and frame, boot lid and frame of motor vehicles prior to spray painting.

In WO 94/10255 there is disclosed an adhesive masking tape for protecting rubber sealing gaskets used to mount motor vehicle windshields during repainting of the vehicles.

In WO 94/20584 there is disclosed a masking tape with a stiffened edge whereby the tape is suitable for insertion under mouldings and gaskets which not only masks the moulding or gasket but also facilitates refinishing.

In WO 95/24273 there is disclosed a method of masking a post located between front and rear doors of a motor vehicle by locating a resiliently conformable strip of masking material between the trailing edge of the front door adjacent the post and the leading edge of the rear door adjacent the post.

In WO 99/52646 there is disclosed a foam strip for preventing paint from entering a gap between a movable panel of a motor vehicle (for example, a door, bonnet or boot lid) and another part of the vehicle (typically a part of the vehicle frame or bodywork) during spray painting.

In many applications, the boundary or edge of the area to be protected is well defined. For example, when masking across a gap between two parts of the vehicle bodywork or when masking up to a sealing or trim strip. For these applications, locating and securing the masking material in the correct position is relatively simple and does not require any particular skill on the part of the user.

In contrast, however, there is no gap or change of material between the protected and painted areas providing a natural break in the paint finish when masking along a swage line. As a result, the masking material has to be applied with a high degree of accuracy to ensure that the areas to be protected and painted merge smoothly and continuously along the swage line with no discernible change in colour between the areas following painting.

The absence of any natural break to assist in locating and aligning the masking material creates special problems when masking along a swage line. Thus, the shape and configuration of the swage line may vary making accurate positioning of the masking material tricky, especially if the masking material and bodywork are of similar colour or colour shade, for example a light coloured masking material applied to light coloured paintwork.

As a result, application of the masking material requires a high degree of skill and often the masking material has to be removed and re-applied to ensure correct positioning so that an acceptable finish is achieved. This is a time consuming operation but failure to locate the masking material accurately will usually require re-painting which is undesirable in terms of the additional painting time and the extra cost of materials used.

### SUMMARY

The present invention provides a masking material that can be used to mask along a swage line of bodywork of a motor vehicle.

Advantageously, the present invention provides a masking material for masking a swage line of bodywork of a motor vehicle more accurately, with greater speed, and/or with more precision than prior masking materials.

In one embodiment, the present invention provides a masking material for masking a swage line of bodywork of a motor vehicle capable of producing an enhanced finish compared with finishes obtainable using masking material known hitherto.

According to a first aspect of the present invention, there is provided a masking material for masking a swage line of an article, the material comprising at least two differently coloured portions and an adhesive stripe for attaching the material to the article so that the colour contrast at the boundary of the differently coloured portions provides a sight line to assist locating the material along the swage line.

By this invention, application of the masking material along a swage line is facilitated by the sight line created by the colour contrast between the different portions of the material. More especially, by using the sight line, the invented masking material can be accurately aligned with and precisely positioned to follow the configuration of the swage line in a simple manner without requiring special skill on the part of the user.

As a result, the invented masking material can be applied more easily and reliably, especially by inexperienced or unskilled users, to protect an area adjacent to a swage line before painting. In this way, an acceptable finish can be obtained with greater certainty by reducing errors or mistakes in the initial application of the masking material that may otherwise require re-painting.

Typically, the two differently coloured portions are arranged to provide a sight line along at least one longitudinal edge of the masking material. In this way, the longitudinal edge of the masking material can be aligned and positioned along the swage line.

Advantageously, the masking material is of generally elongate cross-section having longitudinally extending edges on opposite sides of a longitudinally extending body portion, and said differently coloured portions are provided on opposite sides of the body portion to form a respective sight line along each longitudinal edge. In this way, the masking material can be aligned and positioned along the swage line using the sight line at either longitudinal edge.

Typically, one of the coloured portions is of a relatively light colour such as white and the other, differently coloured portion is of a dark colour such as black. In this way, if the adhesive stripe is applied to the light coloured portion, the masking material can be used to mask along the swage line of a dark coloured vehicle assisted by the light coloured sight line produced between the vehicle bodywork and the dark coloured portion which is uppermost. Similarly, if the adhesive stripe is applied to the dark coloured portion, the masking material can be used to mask along the swage line of a light coloured vehicle assisted by the dark coloured sight line produced between the vehicle bodywork and the light coloured portion which is uppermost.

In one embodiment, adhesive stripes are applied to both of the differently coloured portions. In this way, the masking material can be applied either way up to produce a clearly defined sight line by sticking the coloured portion of contrasting colour to the vehicle bodywork along the swage line. As a result, the same masking material can be used for masking along the swage line of light or dark coloured vehicles and the user can select the appropriate orientation of the masking material for a particular application.

The adhesive may extend over all or part of the surface of the body portion between the longitudinal edges. Where the adhesive extends over part of the surface on one side of the body portion, a single adhesive stripe may be provided at any position between the longitudinal edges, for example adjacent to one of the longitudinal edges or centrally between the longitudinal edges. Alternatively, more than one adhesive stripe may be provided on one side of the body portion, for example two adhesive stripes may be provided adjacent to the longitudinal edges of the body portion. The or each adhesive stripe may be of any shape and configuration, for example linear or zig-zag. Providing an adhesive stripe adjacent to a longitudinal edge of the body portion may assist initial location of the masking material and allow the masking material to be applied along the swage line with greater accuracy.

Advantageously, the masking material comprises an elongate foam strip having differently coloured portions that delimit the sight line when the masking material is applied to the bodywork of a vehicle. The foam may be an open or closed cell polymeric foam that is resiliently compressible. Foams having a density in the range 20 to 30 Kg/m³ are generally found to be useful.

Typically, the foam is cold weldable and a second aspect, the present invention comprises a method of making a masking material comprising the steps of providing a web of foam material, and cold welding the foam web to produce an array of elongate strips of masking material joined by parallel, longitudinal cold weld seams spaced apart across the foam web, with the cold weld seams being separable to detach individual strips of masking material or groups of strips of masking material from the array, and each strip having differently coloured portions providing a sight line to assist in locating the strip in use of the masking material.

Individual strips or group of strips may be wound into a roll of pre-determined length from which a required length of masking material for a particular application can be obtained.

Suitable cold weldable foam materials include polystyrene, polyvinylchloride, polyethylene, polyurethane, polyisocyanate, polyphenol, polyester and silicone foams. The foam material may be cold welded by applying pressure to the foam web with a former such as a rotatable pressure roller or wheel so as to compress the foam web sufficiently to cause the foam to fuse together.

Typically, an adhesive coating is applied prior to or after the cold welding operation so as to provide one or more adhesive stripes on one or both sides of each strip of masking material. Suitable adhesives include pressure sensitive adhesives such as hot melt rubber adhesive applied by any suitable means, for example die coating.

The differently coloured portions may be arranged to provide the sight line along a side edge of the foam strip. For example, the cold weld seam may de-limit the boundary between the differently coloured portions defining the sight line. Sight lines may be provided along one or both side edges of the foam strip. Alternatively, or additionally, one or more sight lines may be provided between the side edges of the foam strip.

The differently coloured portions of the foam strip may be provided in any suitable manner. Thus, one portion may be the colour of the foam with the other portion being a contrasting colour.

The contrasting colour may be provided by a band of paint, ink or dye of different colour to the foam strip. For example we may cold weld a foam web which has been painted or dyed a different colour on one side to form an array of elongate strips of masking material joined by parallel, longitudinal cold weld seams spaced apart across the foam web and separate the cold weld seams to detach individual strips of masking material or groups of strips of masking material.

Alternatively, the contrasting colour may be provided by a panel of flexible material of different colour to the foam strip. For example, we may cold weld a foam web having a sheet of plastic of different colour laminated to one side to form an array of elongate strips of masking material joined by parallel, longitudinal cold weld seams spaced apart across the foam web and separate the cold weld seams to detach individual strips of masking material or groups of strips of masking material. Suitable materials for the plastic sheet include polyurethane and polyolefin but it will be understood other materials may be used.

Alternatively, the foam strip may comprise two or more layers of foam of contrasting colour. For example, we may cold weld at least two superimposed layers of foam web of contrasting colour to form an array of elongate strips of masking material joined by parallel, longitudinal cold weld seams spaced apart across the foam web and separate the cold weld seams to detach individual strips of masking material or groups of strips of masking material.

In one embodiment, the foam strip comprises three or more superimposed layers of foam releasably secured together so as to allow the outermost layers on each side to be removed while maintaining a colour contrast between remaining portions of the foam strip to produce a sight line.

In this way, one or more layers may be selectively removed to adapt the masking material to any required thickness for a given application and/or, to reveal fresh layers after use enabling the masking material to be re-used.

In another embodiment, the masking material comprises a tape having the adhesive stripe on one side. The tape may be made of a relatively thin material that is readily separable manually, for example by tearing. In this way, the tape may be wound on itself into a roll of pre-determined length from which a required length of masking material can be separated for a given application.

In this embodiment, the sight line may be provided by a marginal edge portion of the tape being of different colour to the remaining portion of the tape. For example, one or both sides of a roll of tape may be coloured by ink, paint, dye or any other suitable means to provide a colour contrast when the tape is unwound that is seen as a sight line to assist locating the tape in the required position along the swage line.

Each side of the roll may be coloured differently such that one edge of the tape may provide a sight line to assist locating the tape on the swage line of a light coloured vehicle and the other edge may provide a sight line to assist locating the tape on the swage line of a dark coloured vehicle.

Alternatively or additionally, the differently coloured portions may comprise discrete areas of the tape. For example, the tape may be provided with an area of different colour along one or both longitudinal edges to provide a colour contrast that is seen as a sight line to assist locating the tape in the required position along the swage line.

Each area of different colour may be continuous or discontinuous. Thus, alternating areas of light and dark colour may be used to provide colour contrasts that are seen as sight lines to assist locating the tape in the required position on either light or dark coloured vehicles.

The tape may be formed as multi-layers which are peelable one from another. In this way, the tape may be re-used by removing any layers that have been painted and re-applying the tape.

The invention also provides a method of masking including the steps of providing an elongate masking material having differently coloured portions, manipulating the material so that a sight line of a colour contrasting with the colour of the article is produced, and using the sight line to apply the material to an article in a required position.

Typically, the masking material is provided with adhesive for sticking the masking material to the article. The adhesive may be a pressure sensitive adhesive by means of which the masking material is releasably secured to the article and can be removed after use.

The masking method has particular application for masking along the swage line of a vehicle prior to painting.

Other features, benefits and advantages of the invention will be understood from the description of the exemplary embodiments herein.

### BRIEF DESCRIPTION OF THE DRAWINGS

Examples of the invention in a variety of forms are shown in the accompanying drawings in which:

FIG. 1 is a diagrammatic perspective view of masking material in accordance with one embodiment of the invention in the form of an elongate foam component shown in one configuration;

FIG. 2 is a view corresponding to FIG. 1 showing the masking material in an alternative configuration;

FIG. 3 is a view showing the masking material applied along the swage line of a vehicle in the configuration of FIG. 1;

FIG. 4 is a view, similar to FIG. 3, showing the masking material applied along the swage line in the alternative configuration of FIG. 2;

FIGS. 5A, 5B are diagrammatic views showing the method of manufacturing of the masking material shown in FIGS. 1 and 2;

FIGS. 6A, 6B are diagrammatic views showing the method of manufacturing an alternative form of masking material according to another embodiment of the invention;

FIGS. 7A, 7B are diagrammatic views showing the method of manufacturing another form of masking material according to a further embodiment of the invention;

FIG. 8 is a view showing another form of masking material according to yet another embodiment of the invention;

FIG. 9 is a diagrammatic perspective view of masking material according to a still further embodiment of the invention in the form of an elongate tape;

FIG. 10 is a diagrammatic plan view of masking material in accordance with another embodiment of the present invention;

FIG. 11 is a view corresponding to FIG. 10 showing the masking material in an alternative configuration in accordance with the present invention;

FIG. 12 is a diagrammatic perspective view of another embodiment of masking material according to the present invention; and

FIG. 13 is a view showing use of masking material according to a still further embodiment of the invention for masking across a gap between two panels.

### DETAILED DESCRIPTION

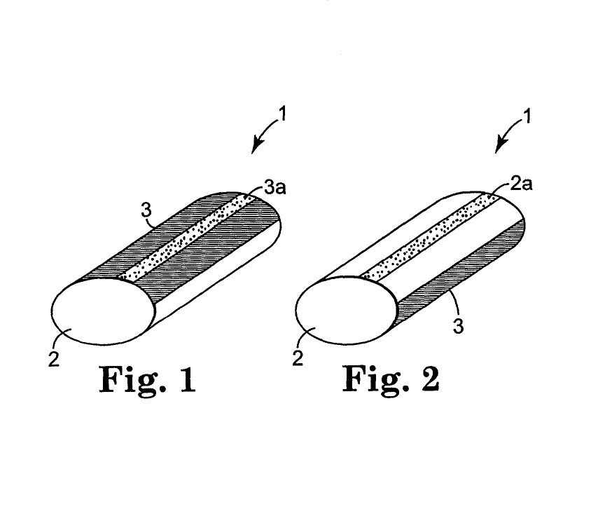

With reference to FIGS. 1 and 2 of the drawings, there is shown a first embodiment of masking material 1 according to the present invention in the form of an elongate component 2 of light coloured foam material having an elongate panel 3 of a dark coloured plastics material laminated thereto.

In this embodiment, the foam material of the component 2 is a resiliently compressible polyester foam coloured white and the plastics material of the panel 3 is polyurethane coloured black. It will be understood, however that other materials and/or colours may be employed for the component 2 and/or panel 3.

The component 2 is of elongate, generally elliptical cross-section. The panel 3 is laminated to the component 2 on one side and extends partially in a circumferential direction of the component 2 such that a contrast in colour between the black plastics of the panel 3 and white foam of the component 2 is provided along both longitudinal edges.

A longitudinal stripe 3a of pressure sensitive adhesive is applied to the outer surface of the panel 3 and a further longitudinal strip 2a of pressure sensitive adhesive is applied to the outer surface of the component 2 on that side remote from the panel 3.

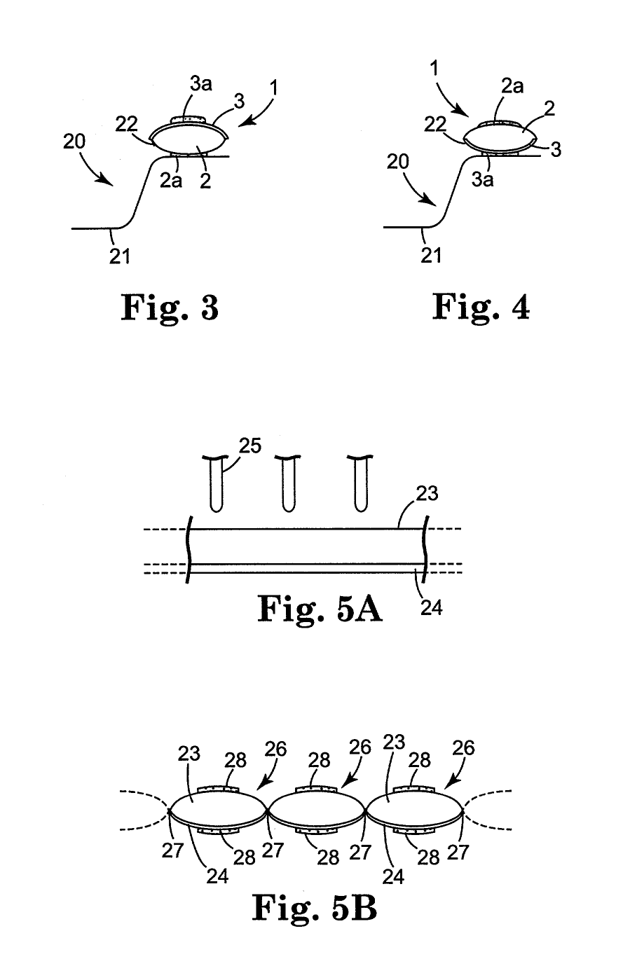

Referring now to FIG. 3, there is shown application of the masking material 1 along a swage line 20 of a dark coloured part 21 of a vehicle, for example the hood. The masking material 1 is arranged with the component 2 facing inwardly towards the bodywork and the panel 3 facing outwardly away from the bodywork. In this orientation, a thin line 22 of white foam from the component 2 is seen between the dark bodywork and the dark panel 3. This provides a sighting line to assist locating the masking material 1 along the swage line 20 enabling the masking material 1 to be secured accurately in the required position by sticking the adhesive stripe 2a to the bodywork. The adhesive stripe 3a on the panel 3 may be used for securing masking paper if required prior to painting

FIG. 4 shows the application of the masking material to mask along a similar swage line 20 of a light coloured part 21 of a vehicle. As shown the configuration of the masking material is reversed from FIG. 3 so that the component 2 faces outwardly away from the bodywork and the panel 3 faces inwardly towards the bodywork.

In this reversed orientation of the masking material, a thin dark line 22 from the panel 3 is seen between the light bodywork and the white foam of component 2. This provides a sighting line to assist locating the masking material 1 along the swage line 20 enabling the masking material 1 to be secured accurately in the required position by sticking the adhesive stripe 3a to the bodywork. The adhesive stripe 2a on the component 2 may be used for securing masking paper if required prior to painting.

As will be apparent, the foam material of the component 2 and the plastics material of panel 3 produce a colour contrast along the edges of the masking material that provide a sight line when the masking material 1 is applied to the bodywork of a vehicle to assist accurate location of the masking material along a swage line.

Furthermore, the masking material 1 can be presented to the bodywork in either one of two orientations depending on the colour of the bodywork so that the sight line is produced adjacent to the surface of the bodywork to allow the masking material 1 to be secured precisely along the swage line.

Referring now to FIGS. 5A, 5B, the steps in a method for making the masking material 1 above described are shown. A single web 23 of white polyester foam having a thickness in the range from 5 mm to 30 mm is laminated on one side to a sheet 24 of black polyurethane as shown in FIG. 5A. The sheet 24 is relatively thin and flexible for conformation of the masking material to a required profile in use.

The polyester foam web 23 is then cold welded by applying pressure to the foam web 23 on that side remote from the polyurethane sheet 24 with a plurality of rotatable pressure rollers 25 spaced part across the web 23. This causes the foam web 23 and the polyurethane sheet 24 to fuse together through the combined thickness to form a plurality of elongate strips 26 of masking material joined together at the edges by parallel longitudinal cold weld seams 27 as shown in FIG. 5B. It will be understood, however, that the cold welding pressure could be applied to the other side of foam web 23 through the polyurethane sheet 24.

The elongate strips 26 are provided on each side with a longitudinal adhesive stripe 28 of pressure sensitive adhesive applied before or after the cold welding operation and are separable along the cold weld seams 27 to allow individual strips 26 of masking material or groups of two or more strips 26 to be detached from the array.

Individual strips 26 or groups of strips 26 of pre-determined length, for example 5 meters may be wound on themselves or on a core to produce a roll of masking material, from which shorter lengths of the masking material can be separated for any given application.

It will be appreciated that the contrasting colour exposed when applying the masking material along a swage line is delimited by the cold weld seams 27 at the longitudinal edges of the strips 26 of masking material and is seen as a sight line to assist locating the masking material as described previously.

In the above-described embodiment, the masking material 1 is provided with a single stripe of adhesive arranged centrally on both sides for securing the masking material 1 in either orientation and optionally attaching masking paper. It will be understood, however that the adhesive stripes can be of any width and may be provided at any position. For example, centrally or offset towards one longitudinal edge of the masking material 1. Alternatively, two or more adhesive stripes may be provided on one or both sides, for example adjacent to the longitudinal edges of the masking material 1. The number and arrangement of the adhesive stripes on each side of the masking material 1 is a matter of choice and other combinations will be apparent to those skilled in the art.

Furthermore, in the above-described embodiment adhesive stripes are applied to both sides of the masking material 1 so that the same masking material 1 may be applied in either one of two orientations as described for use with both dark and light coloured bodywork. It will be appreciated however, that adhesive may be applied to one side only so that the masking material is only suitable for use with vehicles having either dark coloured bodywork or light coloured bodywork depending on the arrangement of the adhesive.

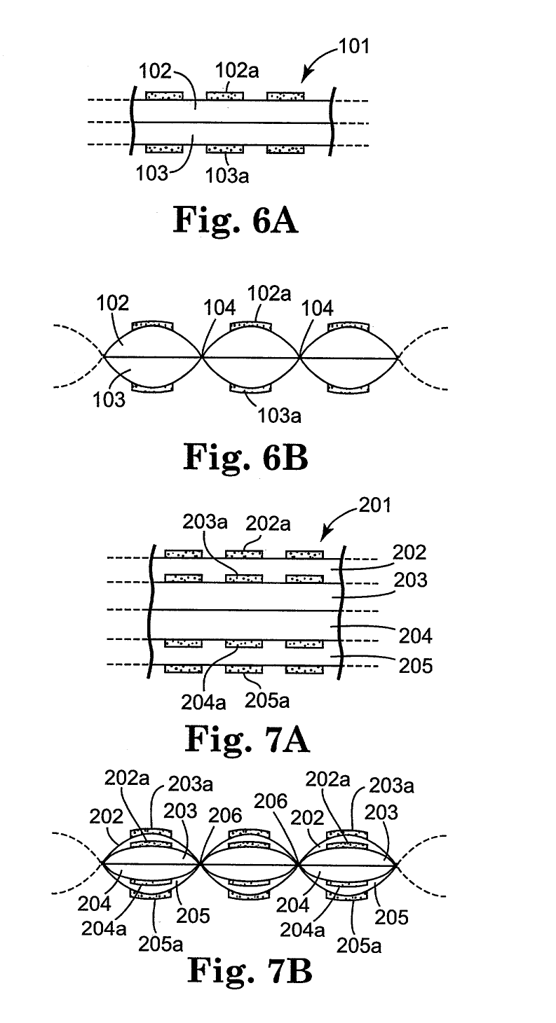

Referring now to FIGS. 6A, 6B, there is shown a second embodiment of masking material 101 according to the present invention. In this embodiment, the contrast in colour is produced by cold welding together two superimposed sheets of foam web 102, 103 of different colour. For example, a sheet of white foam and a sheet of black foam. The foam web sheets 102, 103 may be of the same or different thickness and may be of the same or different foam materials that are suitable for cold welding such as polyester foams as mentioned herein.

The sheets 102, 103 are cold welded at spaced apart positions by applying pressure to cause the foam material to fuse to form an array of elongate strips of masking material joined at the longitudinal edges by cold weld seams 104. The strips are provided with adhesive stripes 102a, 103a on each side before or after the cold welding operation and are separable along the cold weld seams 104 to form individual strips of masking material or groups of strips of masking material which can be would into rolls as described previously.

The cold weld seams 104 delimit a colour contrast between the differently coloured foams 102, 103 at both longitudinal edges that produces a sight line to assist locating the masking material along a swage line of both light and dark coloured vehicles in similar manner to the first embodiment when the masking material is presented to the bodywork in the appropriate orientation.

With reference now to FIGS. 7A, 7B, there is shown a third embodiment of masking material similar to the second embodiment. In this embodiment, the masking material 201 is produced by cold welding four superimposed sheets of foam web 202, 203, 204, 205. The sheets 202, 203 are of the same light coloured foam and the sheets 204, 205 are of the same dark coloured foam.

The sheets are cold welded to form an array of elongate strips of masking material joined together by cold weld seams 206 along the longitudinal edges and are separable into individual strips or groups of strips as described for the previous embodiment. Each strip consists of four layers of foam provided by the sheets 202, 203, 204, 205 and each layer is provided with an adhesive stripe 202a, 203a, 204a, 205a.

The arrangement of the sheets delimits a colour contrast between the outer layers formed by sheets 202, 205 that produces a sight line on first use of the masking material. The outer layers can then be removed to expose the inner layers formed by sheets 203, 204 which also delimit a colour contrast producing a sight line for a second use of the masking material.

In this way, the masking material can be re-used. It will be appreciated that the number and arrangement of differently coloured layers of foam may be chosen to allow the same masking material to be re-used more than once.

A release coat (not shown) may be applied to the inner surface of the outer layers 202, 205 to reduce or prevent adhesion of these layers to the adhesive stripes 203a, 204a of the inner layers 203, 204. In this way, removal of the outer layers 202, 205 is facilitated. Such release coats are well known to those skilled in the art and are typically referred to as LAB's (Low Adhesion Backsize).

Alternatively, a non-stick liner or laminate (not shown) may be incorporated between the layers 202, 203 and 204, 205 to facilitate removal of the outer layers 202, 205. Such liner or laminate may be incorporated during the cold welding process for producing the multi-layer masking material.

Alternatively, removal of the outer layers 202, 205 may be facilitated by sculpting or otherwise shaping the inner surface of the outer layers 202, 205 to minimise contact with the opposed adhesive stripes 203a, 204a of the inner layers 203, 204.

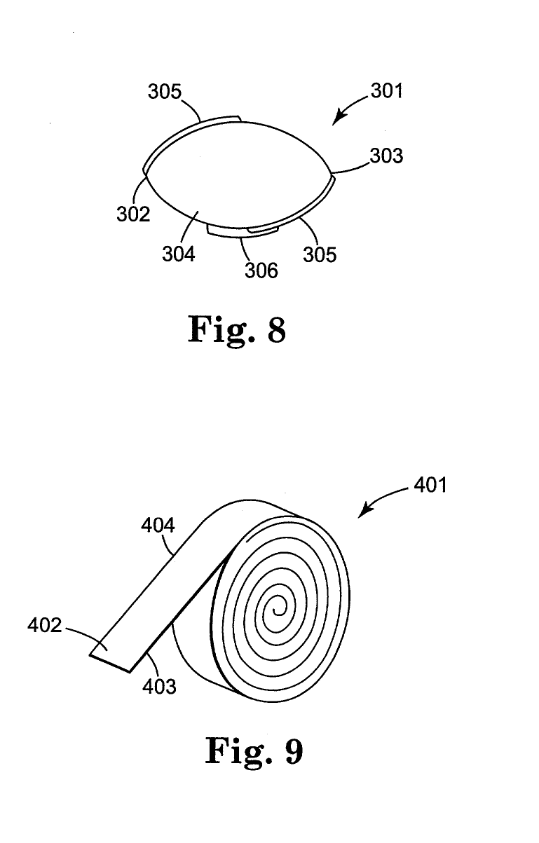

Referring now to FIG. 8, there is shown a fourth embodiment of masking material 301 in which the colour contrast is reversed on the opposite longitudinal edges 302, 303 of the masking material. This is achieved by dividing the outer surface of a white foam component 304 into quarters and attaching black polyurethane sheet 305 to two diametrically opposed quarters leaving the white foam exposed on the other two quarters.

In this way, the masking material can be presented to provide a white sight line along one edge 302 or a black sight line along the opposite edge 303 for use with dark or light coloured vehicles. As a result, an adhesive stripe 306 is required on one side only for securing the masking material to either light or dark coloured vehicles. Other combinations of materials for producing a sight line on one or both longitudinal edges will be apparent to those skilled in the art.

In the above-described embodiments, at least one of the differently coloured portions of the masking material is provided by a foam material. It will be appreciated, however, that the invention is not restricted to such use of foam materials. In FIG. 9, for example, masking material 401 is shown comprising a roll of adhesive tape 402. A longitudinal edge 403 of the tape 402 has a different colour to that of the adjacent surfaces of the tape to provide a sight line to assist locating and aligning the tape 402 along a swage line in the bodywork of a vehicle. The edge 403 may be coloured by applying ink, paint or other suitable colouring material to the side of the roll. The adjacent surfaces of the tape 402 may be transparent.

The other edge 404 may also be coloured to provide a sight line for applying the tape 402. The edge 404 may be the same colour as the edge 403. Alternatively, the edge 404 may be a different colour. Thus, one edge may be coloured to provide a sight line for applying the tape 402 to light coloured vehicles and the other edge may be coloured to provide a sight line for applying the tape 402 to dark coloured vehicles.

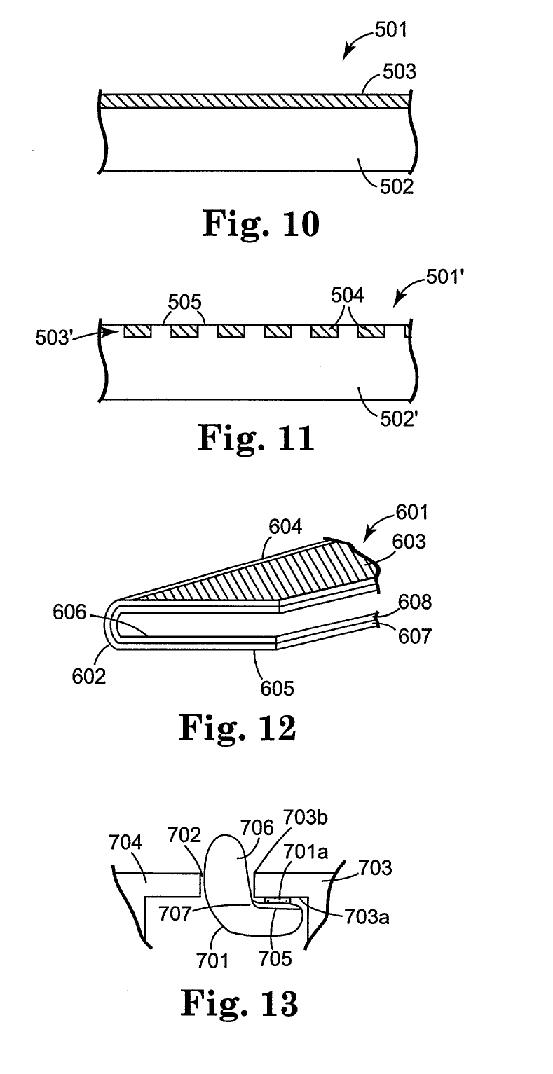

Referring now to FIG. 10, masking material 501 is again shown comprising an adhesive tape 502 in which the upper or outer surface of the tape has a longitudinal edge margin 503 of a colour different from the adjacent portions of the tape to provide a sight line. The adjacent portions may be transparent.

The longitudinal edge margin of a contrasting colour may be continuous as shown in FIG. 10 or discontinuous as shown in FIG. 11. For example, as shown in FIG. 11, the longitudinal edge margin 503′ may be provided with alternating portions 504, 505 of contrasting colour. One of the portions 505 may be the same colour as the tape. The portions 504 may provide a sight line for applying the tape 502′ along a swage line of a dark coloured vehicle, and the portions 505 may provide a sight line for applying the tape along a swage line of a light coloured vehicle or vice versa.

Masking material 601 according to the invention may also comprise dual coloured tape 602 which is folded upon itself and adhesively secured to itself. In FIG. 12, for example, a tape 602 is provided with a longitudinally darkened area 603. In use, the tape 602 is folded longitudinally to provide a sight line 604. An outer surface 605 of the tape 602 is provided with a pressure sensitive adhesive for attaching the tape 602 to a surface and an opposing surface 606 is provided with a pressure sensitive adhesive so as to maintain the tape 602 in a folded condition. The tape 602 may comprise a multi-layer construction so that an outer layer 607 may be peeled off after use and an inner layer 608 functions as an unused masking tape.

Other variations of adhesive tape that can be used as masking material to provide a sight line at one or both longitudinal edges of the tape will be apparent to those skilled in the art.

As will now be understood, the present invention provides masking material that can be applied along a swage line of a vehicle easily and accurately by means of the sight line that is produced by the colour contrast between the differently coloured portions of the masking material.

It will be appreciated however that the benefits and advantages of the invention may have application to masking materials for other uses. For example, FIG. 13 shows masking material 701 in the form of a elongate foam strip used to mask a gap 702 between the front and rear doors 703, 704 of a vehicle by securing the masking material 701 with an adhesive stripe 701a to an inner surface 703a of the trailing edge 703b of the front door 703 so that the gap 702 is masked when the door 703 is closed.

In this application, the masking material 701 is provided with portions 705, 706 of different colour on that side attached to the door 703. The portions 705, 706 delimit a longitudinal sight line 707 to assist aligning the foam strip along the inner surface 703a so that sufficient masking material is exposed to mask the gap 702 when the door is closed.

Other uses of masking materials with portions of contrasting colour to provide sight lines for assisting location of the masking material in a variety of applications will be apparent to those skilled in the art.

It will also be appreciated that the exemplary embodiments described herein are intended to illustrate the diverse range and application of the invention and that features of the embodiments may be employed separately or in combination with any other features of the same or different embodiments to produce any desired masking material.

Moreover, while the specific materials and/or configuration of the masking materials described and illustrated are believed to represent the best means currently known to the applicant, it will be understood that the invention is not limited thereto and that various modifications and improvements can be made within the spirit and scope of the claims.

What is claimed is:

1. A masking material for masking a swage line of an article, the material comprising at least two differently coloured portions and adhesive for attaching the material to the article so that the colour contrast at the boundary of the differently coloured portions provides a sight line to assist locating the material along the swage line.

2. The masking material of claim 1 wherein the masking material is of elongate cross-section and the sight line is provided along a longitudinal edge of the masking material.

3. The masking material of claim 1 wherein sight lines are provided along both longitudinal edges of the masking material.

4. The masking material of claim 1 wherein the masking material can be applied in a selected one of two orientations for use with differently coloured vehicles.

5. The masking material of claim 4 wherein one of the portions is of light colour and the other portion is of dark colour and the masking material is applied in use to position the light coloured portion adjacent to a dark coloured vehicle and the dark coloured portion adjacent to a light coloured vehicle.

6. The masking material of claim 1 wherein the material comprises a foam strip and the colour contrast is provided between differently coloured portions of the strip.

7. The masking material of claim 6 wherein the colour contrast is provided by a band of paint, ink or dye of different colour to the foam strip.

8. The masking material of claim 6 wherein the colour contrast is provided by a panel of flexible material of different colour to the foam material.

9. The masking material of claim 6 wherein the colour contrast is provided by two layers of foam of different colour.

10. The masking material of claim 1 wherein the adhesive is applied to both portions.

11. The masking material of claim 1 wherein the adhesive is arranged in a plurality of stripes.

12. The masking material of claim 1 wherein the material comprises a tape.

13. The masking material of claim 12 wherein the sight line is provided by a differently coloured marginal edge portion of the tape.

14. The masking material of claim 12 wherein the sight line is provided by a differently coloured longitudinal margin of the surface of the tape.

15. The masking material of claim 12 wherein one of the differently coloured portions comprises an area of the tape.

16. The masking material of claim 15 wherein the tape is formed as multilayers which are peelable one from another.

17. The masking material of claim 1 wherein the colour contrast providing the sight line is continuous along the length of the material.

18. The masking material of claim 1 wherein the colour contrast providing the sight line is discontinuous along the length of the material.

19. The masking material of claim 18 wherein one of the portions is provided at spaced intervals along the length of the material.

20. A masking material for masking part of an article, the material comprising at least two differently coloured portions and adhesive for attaching the material to the article so that the colour contrast at the boundary of the differently coloured portions provides a sight line to assist locating the material in a required position.

21. The masking material of claim 20 wherein the material is of elongate cross-section and the sight line is provided at a side edge of the material.

22. The masking material of claim 20 wherein the material is of elongate cross-section and the sight line is provided between side edges of the material.

23. A method of making a masking material comprising the steps of providing a web of foam material, and cold welding the foam web to produce an array of elongate strips of masking material joined by parallel, longitudinal cold weld seams spaced apart across the foam web, with the cold weld seams being separable to detach individual strips of masking material or groups of strips of masking material from the array, and each strip having differently coloured portions providing a sight line to assist in locating the strip in use of the masking material.

24. The method of claim 23 further including the step of providing the colour contrast with a band of paint, ink or dye of different colour to the foam material.

25. The method of claim 23 further including the step of providing the colour contrast with a panel of flexible material of different colour to the foam material.

26. The method of claim 23 further including the step of providing the colour contrast with layers of foam material of different colour.

27. The method of claim 23 further including the step of forming individual strips or group of strips into a roll of pre-determined length from which a required length of masking material for a particular application can be obtained.

28. The method of claim 23 wherein the cold weldable foam material is selected from the group consisting of polystyrene, polyvinylchloride, polyethylene, polyurethane, polyisocyanate, polyphenol, polyester and silicone foams.

29. The method of claim 23 further including the step of applying adhesive prior to or after the cold welding operation so as to provide one or more adhesive stripes on one or both sides of each strip of masking material.

30. A method of masking using the masking material as claimed in claim 1 comprising the steps of:
applying the material to an article having a swage line so the material adheres to the article by means of the adhesive and extends along the swage line, and
manipulating the material so that a sight line of a colour contrasting with the colour of the article extends along the swage line.

31. A method of masking an article comprising the steps of:
providing an elongate masking material having differently coloured portions, manipulating the material so that a sight line of a colour contrasting with the colour of the article is produced, and
using the sight line to locate the material to an article in a required position.

32. The method of claim 31 further including the step of adhesively securing the masking material to the article in the required position.
